(19) United States
(12) Patent Application Publication
(10) Pub. No.: US 2026/0119814 A1
(43) Pub. Date: Apr. 30, 2026

(54) GENERATION DEVICE, GENERATION METHOD, AND RECORDING MEDIUM FOR GENERATING SIMULATED RESPONSE TO QUESTION

(71) Applicant: Rakuten Group, Inc., Tokyo (JP)

(72) Inventors: Kazutoshi KINOSHITA, Tokyo (JP); Eiji FUKUDA, Tokyo (JP)

(21) Appl. No.: 19/339,196

(22) Filed: Sep. 24, 2025

(30) Foreign Application Priority Data
Oct. 28, 2024 (JP) 2024-189341

(51) Int. Cl. G06F 40/40; G06N 3/0475

(52) U.S. Cl. CPC G06F 40/40; G06N 3/0475

(57) ABSTRACT

A generation device includes a classifier, a calculator, an acceptor, and a generator. The classifier classifies candidates capable of responding to a question into a plurality of clusters based on characteristic information of each of the candidates. The calculator calculates, based on the characteristic information of each of the candidates classified to each of the plurality of clusters, a representative characteristic that indicates a characteristic of a representative representing the cluster. The acceptor accepts a question sentence. The generator causes a generative AI server to generate a simulated response to the question sentence accepted by the acceptor. The generative AI server is configured to simulate the representative having the representative characteristic calculated for each of the plurality of clusters.

### CROSS-REFERENCE TO RELATED APPLICATIONS

This application claims the benefit of Japanese Patent Application No. 2024-189341, filed on Oct. 28, 2024, the entire disclosure of which is incorporated by reference herein.

### FIELD OF THE INVENTION

The present disclosure relates to a generation device, a generation method, and a recording medium for generating a simulated response to a question.

### BACKGROUND OF THE INVENTION

Interviews, questionnaires, and other surveys are conducted in various fields with a large number of users via the Internet. As an example, Japanese Patent Application Publication No. 2022-32935 discloses a system capable of realizing digital clone questionnaire surveys to conduct questionnaire surveys faster and at a lower cost than traditional questionnaire surveys.

This system causes a personalized artificial intelligence (AI), which learns individual expressions and generates sentences in accordance with those individual expressions, to output responses to questions in a questionnaire.

### SUMMARY OF THE INVENTION

After conducting the surveys as described above, areas for improvement may be found only after reviewing the gathered responses, for example, that expressions in the questions could have been made differently, or that other questions could have been asked together. In such a case, the surveys needs to be conducted again with modified questions. Therefore, there has been a desire to acquire, prior to conducting the questionnaire, diverse samples of responses for evaluating the validity and appropriateness of the questions.

The present disclosure is made in view of the above situation, and an objective of the present disclosure is to provide a generation device, a generation method, and a recording medium capable of acquiring diverse responses for evaluating the validity and appropriateness of questions in advance.

In order to solve the above problem, a generation device according to the present disclosure includes:
one or more processors to
   classify candidates capable of responding to a question into a plurality of clusters based on characteristic information of each of the candidates,
   calculate, based on the characteristic information of each of the candidates classified to each of the plurality of clusters, a representative characteristic indicating a characteristic of a representative representing the cluster,
   accept a question sentence, and
   cause a generative artificial intelligence to generate a simulated response to the accepted question sentence, the generative artificial intelligence being configured to simulate the representative having the representative characteristic calculated for each of the plurality of clusters.

The present disclosure can provide a generation device, a generation method, and a recording medium capable of acquiring diverse responses for evaluating the validity and appropriateness of questions in advance.

### BRIEF DESCRIPTION OF DRAWINGS

FIG. 1 is an explanatory diagram illustrating connections between a generation device and other devices;

FIG. 2 is an explanatory diagram illustrating a functional configuration of the generation device;

FIG. 3 illustrates an example of an attribute table stored in a user database (DB) illustrated in FIG. 2;

FIG. 4 illustrates an example of an action history table stored in the user DB illustrated in FIG. 2;

FIG. 5 illustrates an example of a classification result table generated by a classifier illustrated in FIG. 2;

FIG. 6 illustrates an example of a representative characteristic table generated by a calculator illustrated in FIG. 2;

FIG. 7 is an explanatory diagram illustrating a physical configuration of the generation device;

FIG. 8 is a flowchart of candidate classification processing to be performed by the generation device;

FIG. 9 is a flowchart of response generation processing to be performed by the generation device;

FIG. 10 illustrates an example of a prompt generated by a generator illustrated in FIG. 2; and

FIG. 11 illustrates an example of a response table generated by the generator.

### DETAILED DESCRIPTION OF THE INVENTION

A generation device, a generation method, and a program according to an embodiment of the present disclosure are described in detail with reference to the drawings. The same or corresponding parts in the drawings are designated by the same reference signs. Note that the present embodiment is intended for description and is not intended to limit the scope of the present disclosure. Accordingly, it is possible for persons skilled in the art to employ an embodiment in which part or all of the elements of the embodiment are replaced by equivalents thereof, which are also included in the scope of the present disclosure.

### Overall Configuration

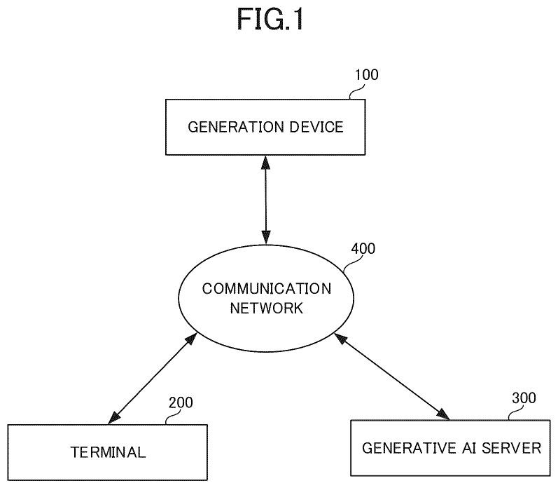

FIG. 1 is an explanatory diagram illustrating connections between a generation device 100 and other devices according to the embodiment of the present disclosure. As illustrated in FIG. 1, the generation device 100 is communicably connected to a terminal 200 and a generative artificial intelligence (AI) server 300 via a communication network 400. Although one terminal 200 is illustrated in FIG. 1, the number of applicable terminals 200 is not limited thereto, and a plurality of terminals 200 may be applied.

The generation device 100 includes one or a plurality of server computers. The generation device 100 is operated by, for example, a provider that provides a crowdsourcing service for requesting an unspecified large number of users to perform tasks including responding to a questionnaire.

The generation device 100 is a device for accepting question sentences in a questionnaire and generating simulated responses to the accepted question sentences. Specifically, the generation device 100 classifies candidates capable of responding to the questionnaire into a plurality of clusters based on characteristic information of each of the candidates. The characteristic information includes, for example, attributes of each of the candidates, such as age, gender, and occupation, and an action history of the candidate, such as purchases of products and responses to past questionnaires.

The generation device 100 calculates, for each of the clusters to which the candidates have been classified, a representative characteristic that indicates a characteristic of a representative representing the cluster. Based on the representative characteristic calculated for each of the clusters, the generation device 100 generates, for each of the clusters, a prompt for instructing the generative AI server 300 to simulate the above representative and generate the simulated responses to the question sentences. The generation device 100 transmits the prompt generated for each of the clusters to the generative AI server 300, and causes the generative AI server 300 to generate the simulated response to the question sentences.

The terminal 200 is an information terminal (a so-called computer) such as a tablet or a smartphone, and is a terminal to be used by, for example, a requester that is a company or an individual requesting to perform the questionnaire via the crowdsourcing service. The requester uses the terminal 200 to generate the question sentences in the questionnaire and view the simulated responses generated by the generation device 100 to modify the question sentences.

The generative AI server 300 includes an AI that generates the responses using, as an input, the prompt for instructing generation of the responses to the question sentences. The generative AI server 300 includes, for example, a sentence generation AI that generates sentences. Examples of the sentence generation AI include ChatGPT, GEMINI, Catchy, Notion AI, other sentence generation Als, or programs, services, or software using the above.

Examples of the model of the sentence generation AI include any language models or large-scale language models, such as GPT, PaLM, LaMDA, LLaMa, Claude, OpenCALM, or language models or large-scale language models modified, improved, transfer-trained, or additionally trained from the above.

The generative AI server 300 may further include an image generation AI and have a function of generating an image.

The communication network 400 may include various types of networks. Examples thereof include a local area network (LAN), a wide area network (WAN) such as the Internet, a telecommunication network such as a public switched telephone network (PSTN), a wireless network, a public switched network, a satellite network, a cellular network, a public land mobile network (PLMN), a metropolitan area network (MAN), a private network, an ad hoc network, an intranet, a fiber optic-based network, and a combination of the above or other types of networks.

### Functional Configuration of Generation Device

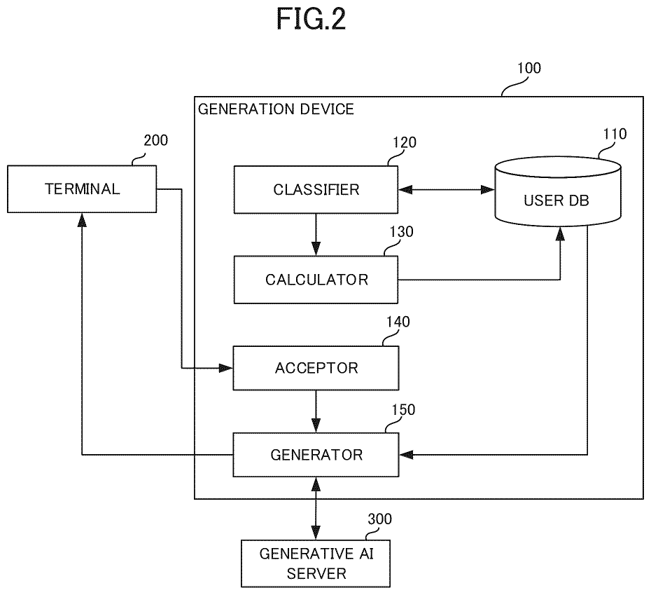

FIG. 2 is an explanatory drawing illustrating a functional configuration of the generation device 100. The generation device 100 includes a user DB 110, a classifier 120, a calculator 130, an acceptor 140, and a generator 150.

The user DB 110 is a database for storing the characteristic information of each of the candidates capable of responding to the questionnaire, and storing responses of the candidates to past questionnaires, a result of classification of the candidates performed by the classifier 120, and the representative characteristic calculated by the calculator 130. The candidates capable of responding to the questionnaire are, for example, users registered in the crowdsourcing service. These users receive and perform the tasks provided by the requester online. Among all of the users registered in the crowdsourcing service, for example, users that have not logged in or have not performed any tasks for a certain period of time may be excluded from the candidates, or users meeting predetermined conditions may be extracted as the candidates.

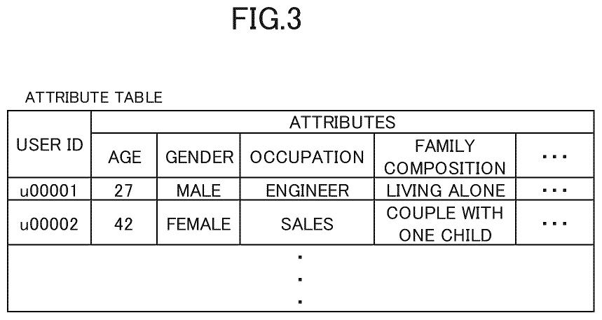

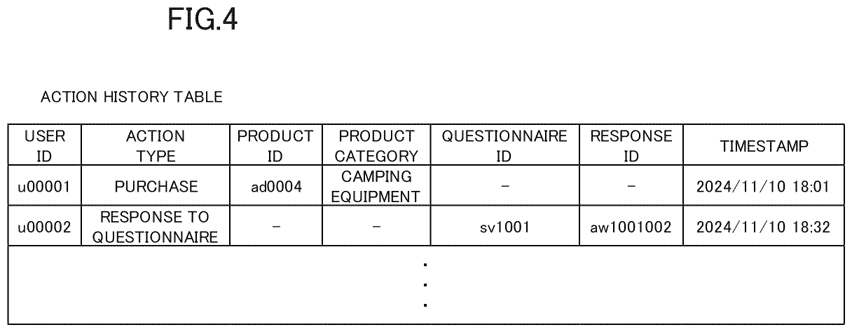

Specifically, the user DB 110 includes an attribute table that stores attribute information of each of the candidates, and an action history table that stores the action history of each of the candidates. Here, examples of the attribute table and the action history table are illustrated in FIGS. 3 and 4, respectively.

As illustrated in FIG. 3, the attribute table includes “User ID” that is information for uniquely identifying each of the candidates, and “Attributes” that indicate attributes of the candidate, such as age, gender, occupation, and family composition. The attributes are not limited to those illustrated in FIG. 3, and may further include other information of each of the candidates, such as address, academic background, and income, or may be a combination including any other information.

As illustrated in FIG. 4, the action history table includes “User ID” that is information for uniquely identifying each of the candidates, “Action Type” that indicates a type of action taken by the candidate, “Product ID” that is information for uniquely identifying a product purchased by the candidate, “Product Category” that indicates a category of the product purchased by the candidate, “Questionnaire ID” that is information for uniquely identifying a questionnaire to which the candidate has responded in the past, “Response ID” that is information for uniquely identifying a response of the candidate, and “Timestamp” that indicates the date and time at which the action has been taken. “Action Type” includes either “Purchase” or “Response to Questionnaire” in the illustrated example, but is not limited thereto. “Action Type” may further include any other actions, such as viewing a product page, searching for a product, and registering a brand, a store, or the like as a favorite. The information related to a purchase of a product or the like may be acquired from a non-illustrated management server that manages an electronic commerce service.

Returning back to FIG. 2, the classifier 120 classifies the candidates capable of responding to the questionnaire into the plurality of clusters. Specifically, the classifier 120 classifies the plurality of candidates stored in the user DB 110 into the plurality of clusters based on the characteristic information of each of the candidates. For example, the classifier 120 compares feature vectors, in each of which the characteristic information (the attributes and the action history) of each of the candidates is vectorized, and performs classification based on the similarity or distance between the feature vectors. A classification method may be hierarchical or non-hierarchical. As a calculation method used in hierarchical classification, any methods, such as a Ward's method, a group average method, a shortest distance method, and a longest distance method, can be used. As a calculation method used in non-hierarchical classification, any methods, such as a k-means method, can be used.

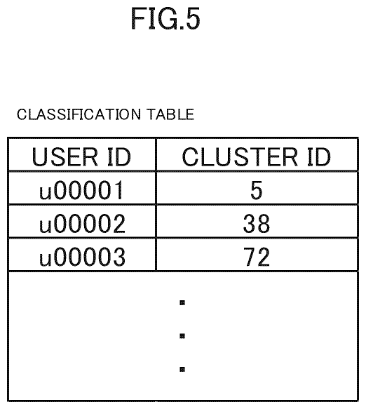

The classifier 120 generates a classification result table that indicates the result of classification, and causes the user DB 110 to store the classification result table. Here, an example of the classification result table is illustrated in FIG. 5. As illustrated in FIG. 5, the classification result table is a table associating “User ID” that is information for uniquely identifying each of the candidates, with “Cluster ID” that is information for uniquely identifying a cluster to which the candidate has been classified by the classifier 120.

Returning back to FIG. 2, the calculator 130 calculates the representative characteristic that indicates the characteristic of the representative representing each of the plurality of clusters to which the candidates have been classified by the classifier 120. For example, the calculator 130 generates a representative vector based on the feature vectors of the plurality of candidates included in each of the clusters. For example, the calculator 130 calculates, as the representative vector of each of the clusters, the center of gravity of the feature vectors of all of the candidates included in the cluster or the feature vector of a candidate closest to this center of gravity. The calculator 130 generates, based on the calculated representative vector, a representative characteristic table that stores the representative characteristic of each of the clusters.

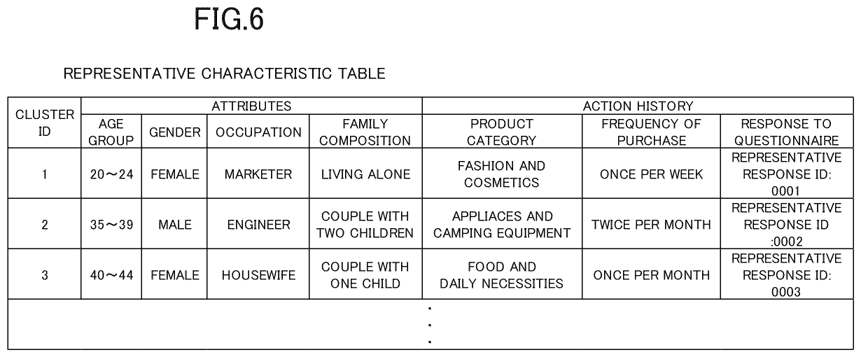

Here, an example of the representative characteristic table is illustrated in FIG. 6. As illustrated in FIG. 6, the representative characteristic table includes “Cluster ID” that is information for uniquely identifying each of the clusters, “Attributes” that include “Age Group”, “Gender”, “Occupation”, and “Family Composition” of the representative of the cluster, and “Action History” that includes “Product Category” of purchased products, “Frequency of Purchase” of the products, and “Response to Questionnaire” that is information for uniquely identifying data of a response of the representative to a past questionnaire.

Returning back to FIG. 2, the acceptor 140 accepts the question sentences. Specifically, the acceptor 140 awaits the question sentences and receives the question sentences transmitted from the terminal 200.

The generator 150 generates the responses to the question sentences accepted by the acceptor 140. Specifically, the generator 150 generates, for each of the clusters, the prompt for instructing the generative AI server 300 to simulate the representative and generate the responses to the question sentences, based the representative characteristic calculated by the calculator 130 for each of the clusters and the accepted question sentences.

The generator 150 transmits the generated prompt to the generative AI server 300, and acquires the responses generated by the generative AI server 300. Processing of the generator 150 is described later in detail. The generative AI server 300 may be configured to be a partial function of the generator 150.

### Hardware Configuration of Information Processing Device

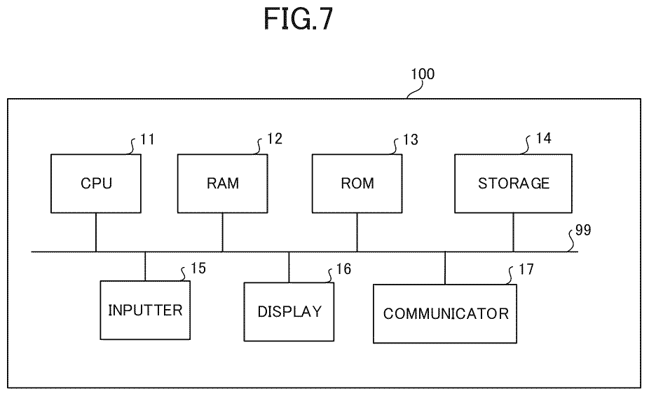

FIG. 7 is a block diagram illustrating a hardware configuration of the generation device 100. The generation device 100 includes a central processing unit (CPU) 11 that performs processing in accordance with a program, a random access memory (RAM) 12 that is a volatile memory, a read only memory (ROM) 13 that is a non-volatile memory, a storage 14 that stores data, an inputter 15 that accepts an input of information, a display 16 that displays information visually, and a communicator 17 that transmits and receives information, which are connected via an internal bus 99.

The CPU 11 controls operations of the entire generation device 100, and is connected with each of the components to exchange a control signal or data with each other. The CPU 11 performs various types of processing by reading a program stored in the storage 14 into the RAM 12 and executing the program. The CPU 11 performs, as main functions provided by the program, processing of each of the classifier 120, the calculator 130, the acceptor 140, and the generator 150.

The RAM 12 is for temporarily recording data or a program, and holds the program or data read from the storage 14, other data necessary for communication, and the like. The RAM 12 is used as a work area for the CPU 11.

The ROM 13 stores a control program to be executed by the CPU 11 for a basic operation of the generation device 100, a basic input/output system (BIOS), and the like.

The storage 14 includes a hard disk drive, a flash memory, and the like, stores the program to be executed by the CPU 11, and stores various types of data to be used in execution of the program. The storage 14 functions as the user DB 110.

The inputter 15 is a user interface including a touch panel, a keyboard, a mouse, a communication device, and the like. The inputter 15 accepts an operation input from a user of the generation device 100, and outputs a signal corresponding to the accepted operation input to the CPU 11.

The display 16 is a display device for displaying information visually, such as a liquid crystal display or an organic electro luminescence (EL) display.

The communicator 17 is a network termination device or a wireless communication device connected to a network, and a serial interface or a local area network (LAN) interface connected to the network termination device or the wireless communication device. The generation device 100 intercommunicates with the terminal 200, the generative AI server 300, and other devices via the communicator 17. The communicator 17 functions as the acceptor 140.

### Candidate Classification Processing

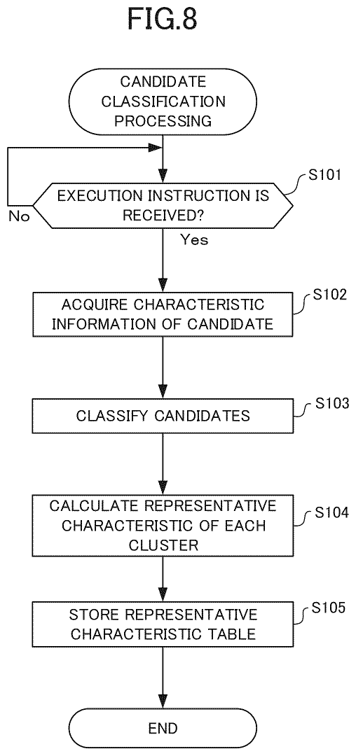

Next, operations of the generation device 100 are described with reference to the drawings. First, candidate classification processing for classifying the candidates capable of responding to the questionnaire into the plurality of clusters and calculating the representative characteristic of the representative representing each of the clusters is described with reference to FIG. 8.

The candidate classification processing is started, for example, by an execution instruction from an administer of the generation device 100. The generation device 100 may be configured to start the candidate classification processing at a predetermined timing, such as daily, weekly, or monthly.

The classifier 120 awaits the execution instruction, and when receiving the execution instruction (Yes in step S101), proceeds to step S102. When receiving no execution instruction (No in step S101), the classifier 120 awaits the execution instruction.

In step S102, the classifier 120 acquires the characteristic information of each of the candidates capable of responding to the questionnaire (step S102). Specifically, the classifier 120 accesses the user DB 110 and reads the attribute table illustrated in FIG. 3 and the action history table illustrated in FIG. 4.

Next, the classifier 120 classifies the candidates into the plurality of clusters (step S103). Specifically, the classifier 120 classifies the candidates into the plurality of clusters based on the attributes and the action history of each of the candidates. For example, the classifier 120 calculates, using any classification method, the similarity and distance between the candidates based on the feature vectors, in each of which the attributes and the action history of each of the candidates are vectorized, to classify the candidates. In a case of categorical data, such as gender or occupation, or data with no numerical size or order, such as a response in a questionnaire, it is sufficient to convert the data to a numerical value to generate the feature vector. The classifier 120 generates the classification result table that indicates the result of classification illustrated in FIG. 5, and causes the user DB 110 to store the classification result table.

Next, the calculator 130 calculates the representative characteristic of the representative representing each of the plurality of clusters generated in step S103 (step S104). For example, the calculator 130 generates the representative vector based on the feature vectors of the candidates included in each of the clusters. For example, the calculator 130 calculates, as the representative vector of each of the clusters, the center of gravity of the feature vectors of all of the candidates included in the cluster or the feature vector of a candidate closest to this center of gravity. The calculator 130 calculates the center of gravity of the feature vectors by averaging the feature vectors of all of the candidates included in the cluster. When calculating the representative characteristic for responses to an open-ended questionnaire, a configuration may be provided in which the feature vectors are generated using any method, such as Bag of Words (BoW), TF-IDF, or Word Embeddings, to identify the most frequently used words and phrases or extract representative topics for each of the clusters based on the feature vectors.

The calculator 130 generates, based on the calculated representative vector, the representative characteristic table illustrated in FIG. 6, which stores the representative characteristic of each of the clusters, causes the user DB 110 to store the representative characteristic table (step S105), and ends the candidate classification processing.

### Response Generation Processing

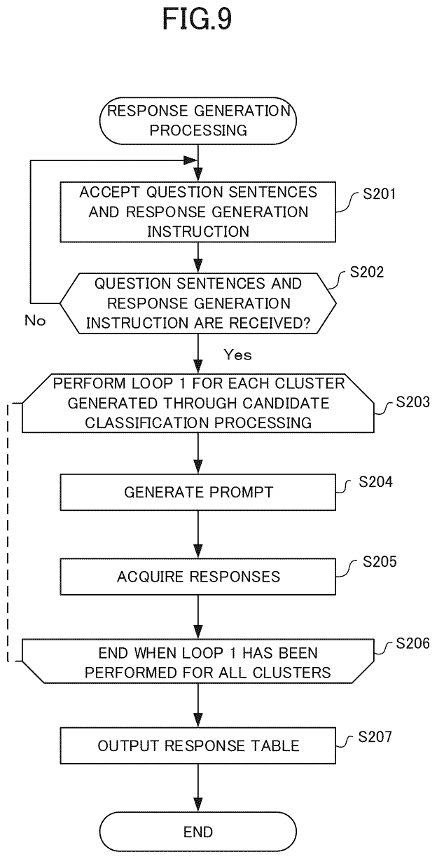

Next, response generation processing to be performed by the generation device 100 is described with reference to FIG. 9.

The acceptor 140 accepts the question sentences and a response generation instruction for instructing generation of responses to the question sentences (step S201). Specifically, the terminal 200 transmits, in accordance with an operation performed by the requester, the response generation instruction together with the generated question sentences to the generation device 100.

When receiving the question sentences and the response generation instruction (Yes in step S202), the acceptor 140 transmits the received question sentences to the generator 150, and proceeds to step S203. When receiving no question sentences and no generation instruction for instructing generation of simulated responses (No in step S202), the accepter 140 returns back to step S201, and accepts the question sentences.

Next, the generator 150 repeats the processing in steps S204 to S206 for each of the clusters generated through the candidate classification processing (step S203).

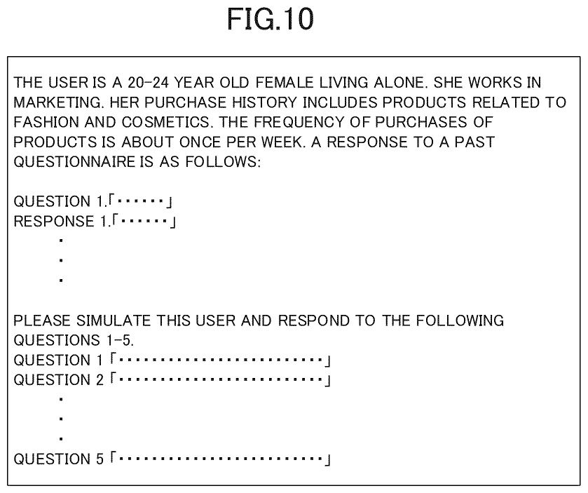

In step S204, the generator 150 generates, based on the question sentences received in step S202 and the representative characteristic of each of the clusters, the prompt for instructing the generative AI server 300 to simulate the representative of the cluster and generate the responses. Here, an example of the prompt is illustrated in FIG. 10. The illustrated example is a prompt for instructing simulation of a representative of a cluster with a cluster ID of 1 and generation of simulated responses to question sentences 1 to 5. This prompt is generated based on the attributes and the action history of the representative of the cluster with a cluster ID of 1, which are stored in the representative characteristic table illustrated in FIG. 6.

In step S205, the generator 150 acquires the responses. Specifically, the generator 150 transmits the prompt generated in step S204 to the generative AI server 300. The generator 150 acquires the responses generated by the generative AI server 300.

Next, in step S206, the generator 150 determines whether the processing of loop 1 has been performed for all of the clusters. When determining that there is an unprocessed cluster, the generator 150 performs the processing of loop 1 for the unprocessed cluster. When determining in step S206 that the processing of loop 1 has been performed for all of the clusters included in the representative characteristic table, the generator 150 proceeds to step S207.

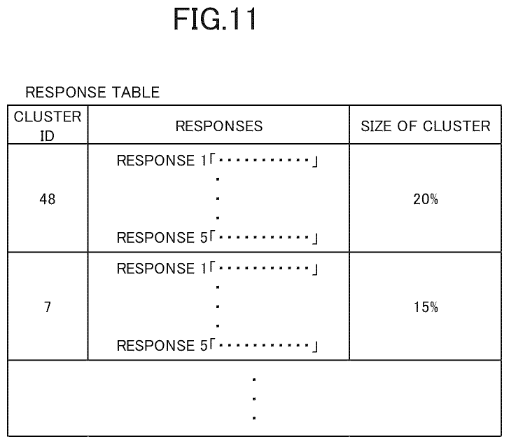

In step S207, the generator 150 outputs a response table that indicates a list of the simulated responses, and ends the processing. Here, an example of the response table is illustrated in FIG. 11. As illustrated in FIG. 11, the response table is a table storing the cluster IDs and the simulated responses in association with each other. In addition to the responses, as illustrated in FIG. 11, the response table may further store the size of each of the clusters, that is, the percentage of the number of candidates in the cluster to the total number of candidates. This allows the requester of the questionnaire to predict what kind of responses to the question sentences are likely to be gathered. The response table may include the representative characteristic of each of the clusters and/or the question sentences.

When viewing the simulated responses and determining that the question sentences need to be modified, the requester of the questionnaire modifies the question sentences and performs the response generation processing again. Repeatedly performing the response generation processing allows to generate more appropriate question sentences for acquiring responses meeting a purpose of the questions.

As described above, the generation device 100 classifies, based on the characteristic information, the candidates responding to the questionnaire into the plurality of clusters, and generates simulated responses of the representative of each of the clusters. This allows to acquire diverse responses for evaluating the validity and appropriateness of questions in advance.

The generation device 100 also classifies the candidates based on the characteristic information of each of the actual candidates stored in the user DB 110, and provides the generative AI server 300 with the representative characteristic of the representative representing each of the clusters. This allows to acquire more realistic variations of the responses.

### Modified Example

The generation device 100 is described in the above embodiment that accepts the question sentences from the terminal 200 and generates the simulated responses, but is not limited thereto. The generation device 100 may accept questions from a chatbot for acquiring responses in a questionnaire through communications with users, and generate simulated responses to the accepted questions. In such a configuration, it is sufficient that the generation device 100 is connected to a chatbot server, generates a prompt for causing the generative AI server 300 to generate the responses to the questions transmitted from the chatbot, and transmits the prompt to the generative AI server 300. For example, it is sufficient that the generation device 100 transmits, to the generative AI server 300, a prompt including the representative characteristic of any of the plurality of clusters to which the candidates have been classified, to perform a series of communications with the chatbot for the number of the clusters. This allows, for example, to verify operations of a chatbot under development by means of diverse response patterns without human intervention, or to simulate a chatbot in operation for the purpose of improving the performance thereof. The above communications with the chatbot may be in an interview format. For example, instead of outputting common questions in advance, the chatbot server may output individual questions for each user in a dialogue format to acquire responses by delving into the content of opinions of the user (for example, the emotion of the responses of the user). That is, the generation device 100 may perform the processing on questions in an interview as well as questions in a questionnaire.

The generation device 100 may further include a determiner for determining whether the question sentences are appropriate. For example, the determiner evaluates, based on the plurality of responses in each of the clusters included in the response table output in step S207, the diversity of the responses and the relevance of the questions and the responses, and determines, based on a result of evaluation, whether the question sentences are appropriate. When evaluating the diversity of the responses, it is sufficient that, for example, the determiner converts each of the plurality of generated responses into a vector, calculates the similarity between the responses using cosine similarity or the like, and evaluates that a lower similarity indicates a higher diversity and a higher similarity indicates a lower diversity. When the similarity is a threshold or greater, it is sufficient that the determiner determines that the question sentences are not appropriate because the range of responses is restricted, and outputs this result of determination.

When evaluating the relevance of the questions and the responses, it is sufficient that, for example, the determiner vectorizes the questions and the generated responses, calculates the cosine similarity between the questions and the responses, and calculates the average of the cosine similarity between the question sentences and the generated responses as a relevance score. The relevance score indicates how semantically relevant the generated responses are to the questions. Therefore, when the calculated relevance score is a threshold or less, it is sufficient that the determiner determines that the question sentences are not appropriate because the questions are ambiguous and thus may not convey the intent thereof, and outputs this result of determination.

Further, when the determiner determines that the question sentences are not appropriate, the generator 150 may transmit, to the generative AI server 300, a prompt for instructing modification of the question sentences to cause the generative AI server 300 to generate question sentences reflecting the result of evaluation. For example, when the diversity of the question sentences are evaluated to be low, it is sufficient that the generator 150 generates a prompt such as “Please modify the question sentences to elicit different perspectives and a variety of opinions.” When the relevance of the questions and the responses is evaluated to be low, it is sufficient that the generator 150 generates a prompt such as “Please modify the question sentences to be clearer and more specific.”

The generation device 100 according to the above embodiment is implementable using a general computer instead of a dedicated device. For example, the generation device 100 that performs the above processing may be configured by installing, from a recording medium storing a program to cause the computer to perform any of the above types of processing, the program in the computer. In addition, the generation device 100 may be configured by a plurality of computers operating in collaboration with one another.

When the above functions are achieved by sharing of operation between an operating system (OS) and an application or by cooperation between the OS and the application, only a part other than the OS may be stored in the medium.

In addition, it is possible to superimpose programs on a carrier wave and distribute the programs via a communication network. For example, the programs may be distributed through an application store (an app store), or may be posted on a bulletin board system (BBS) on the communication network and distributed via the network. Then, these programs may be configured to perform the above processing by starting and executing the programs in a manner similar to other application programs under the control of the OS.

In addition, the information stored in the storage 14 may be collectively managed by a cloud server existing on the network, and the generation device 100 may access the cloud server to perform reading and writing of the information as needed. In such a configuration, the generation device 100 does not have to include the user DB 110. Moreover, the candidate classification processing and the response generation processing performed by the generation device 100 may be performed on a cloud using the information stored in the cloud server.

The various aspects of the present disclosure are described as Appendices.

### APPENDIX 1

A generation device comprising:
one or more processors to
   classify candidates capable of responding to a question into a plurality of clusters based on characteristic information of each of the candidates,
   calculate, based on the characteristic information of each of the candidates classified to each of the plurality of clusters, a representative characteristic indicating a characteristic of a representative representing the cluster,
   accept a question sentence, and
   cause a generative artificial intelligence to generate a simulated response to the accepted question sentence, the generative artificial intelligence being configured to simulate the representative having the representative characteristic calculated for each of the plurality of clusters.

### APPENDIX 2

The generation device according to appendix 1, wherein
the characteristic information includes an attribute and an action history of each of the candidates.

### APPENDIX 3

The generation device according to appendix 1 or 2, wherein
the one or more processors calculate the representative characteristic of each of the plurality of clusters based on the characteristic information of a candidate closest to a center of gravity of the cluster among the candidates classified to the cluster.

### APPENDIX 4

The generation device according to appendix 1 or 2, wherein
the one or more processors calculate an average value of the characteristic information as the representative characteristic for each of the plurality of clusters to which the candidates have been classified.

### APPENDIX 5

The generation device according to any one of appendices 1 to 4, wherein
the one or more processors generate, based on the accepted question sentence and the calculated representative characteristic, a prompt for instructing the generative artificial intelligence to simulate a representative having the calculated representative characteristic and generate a response to the question sentence, and transmit the generated prompt to the generative artificial intelligence.

### APPENDIX 6

The generation device according to any one of appendices 1 to 5, wherein
the one or more processors output the generated response and a size of a cluster corresponding to the generated response in association with each other.

### APPENDIX 7

A generation method comprising:
classifying, by a computer, candidates capable of responding to a question into a plurality of clusters based on characteristic information of each of the candidates;
calculating, by the computer, based on the characteristic information of each of the candidates classified to each of the plurality of clusters, a representative characteristic indicating a characteristic of a representative representing the cluster;
accepting, by the computer, a question sentence; and
causing, by the computer, a generative artificial intelligence to generate a simulated response to the accepted question sentence, the generative artificial intelligence being configured to simulate the representative having the representative characteristic calculated for each of the plurality of clusters.

### APPENDIX 8

A computer-readable recording medium storing a program, the program causing a computer to perform processing comprising:
classifying candidates capable of responding to a question into a plurality of clusters based on characteristic information of each of the candidates;
calculating, based on the characteristic information of each of the candidates classified to each of the plurality of clusters, a representative characteristic indicating a characteristic of a representative representing the cluster;
accepting a question sentence; and
causing a generative artificial intelligence to generate a simulated response to the accepted question sentence, the generative artificial intelligence being configured to simulate the representative having the representative characteristic calculated for each of the plurality of clusters.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

The present disclosure can be suitably used for a generation device, a generation method, and a recording medium capable of acquiring diverse responses for evaluating the validity and appropriateness of questions in advance.

1. A generation device comprising:
one or more processors to
classify candidates capable of responding to a question into a plurality of clusters based on characteristic information of each of the candidates,
calculate, based on the characteristic information of each of the candidates classified to each of the plurality of clusters, a representative characteristic indicating a characteristic of a representative representing the cluster,
accept a question sentence, and
cause a generative artificial intelligence to generate a simulated response to the accepted question sentence, the generative artificial intelligence being configured to simulate the representative having the representative characteristic calculated for each of the plurality of clusters.

2. The generation device according to claim 1, wherein
the characteristic information includes an attribute and an action history of each of the candidates.

3. The generation device according to claim 1, wherein
the one or more processors calculate the representative characteristic of each of the plurality of clusters based on the characteristic information of a candidate closest to a center of gravity of the cluster among the candidates classified to the cluster.

4. The generation device according to claim 1, wherein
the one or more processors calculate an average value of the characteristic information as the representative characteristic for each of the plurality of clusters to which the candidates have been classified.

5. The generation device according to claim 1, wherein
the one or more processors generate, based on the accepted question sentence and the calculated representative characteristic, a prompt for instructing the generative artificial intelligence to simulate a representative having the calculated representative characteristic and generate a response to the question sentence, and transmit the generated prompt to the generative artificial intelligence.

6. The generation device according to claim 1, wherein
the one or more processors output the generated response and a size of a cluster corresponding to the generated response in association with each other.

7. A generation method comprising:
classifying, by a computer, candidates capable of responding to a question into a plurality of clusters based on characteristic information of each of the candidates;
calculating, by the computer, based on the characteristic information of each of the candidates classified to each of the plurality of clusters, a representative characteristic indicating a characteristic of a representative representing the cluster;
accepting, by the computer, a question sentence; and
causing, by the computer, a generative artificial intelligence to generate a simulated response to the accepted question sentence, the generative artificial intelligence being configured to simulate the representative having the representative characteristic calculated for each of the plurality of clusters.

8. A computer-readable recording medium storing a program, the program causing a computer to perform processing comprising:
classifying candidates capable of responding to a question into a plurality of clusters based on characteristic information of each of the candidates;
calculating, based on the characteristic information of each of the candidates classified to each of the plurality of clusters, a representative characteristic indicating a characteristic of a representative representing the cluster,
accepting a question sentence; and
causing a generative artificial intelligence to generate a simulated response to the accepted question sentence, the generative artificial intelligence being configured to simulate the representative having the representative characteristic calculated for each of the plurality of clusters.
